(19) United States
(12) Patent Application Publication
(10) Pub. No.: US 2006/0032111 A1
(43) Pub. Date: Feb. 16, 2006

(54) Conductor connector and methods for making and using the same

(76) Inventors: Douglas H. Willard, Kirkland, WA (US); Rick A. Mix, Poulsbo, WA (US); Christopher B. Cook, Bothell, WA (US)

Correspondence Address: Robert M. Storwick, PO Box 386, Mercer Island, WA, 98040, US

(21) Appl. No.: 10/915,655

(22) Filed: Aug. 10, 2004

(51) Int. Cl. A01M 23/38

(52) U.S. Cl. 43/98

(57) ABSTRACT

A conductor connector and methods for making and using the same. The conductor connector can be used to connect a terminal of an electrical supply to an electrical conductor or to connect two lengths of electrical conductors together. The conductor connector includes a connector body that holds two connector conductors and is adapted to receive the electrical conductors. The connector conductors have ends that are flattened and pressed against the ends of the electrical conductors when the connector body receives the electrical conductors.

### TECHNICAL FIELD

The present invention relates to methods and apparatus for connecting electrical apparatus, and more particularly, to a conductor connector and methods for making and using the same.

### BACKGROUND OF THE INVENTION

It is known that electrified pairs of electrical conductors are useful for diverting birds from attempting to roost on buildings and other structures. However, it is important that the electrical conductors be separated in some predetermined way for them to be most effective. For example, in one significant application, it is desired for the two electrical conductors to be separated by a fixed distance.

In order to maintain the desired separation between the electrical conductors, it is helpful to control their separation by placing them on a supporting base. This allows lengths of the electrical conductors to be manufactured in lengths that can be cut as appropriate when being installed and the cut lengths then being electrically connected together so that all of the lengths are electrified.

Those experienced in the installation of such bird diversion equipment have learned that their performance is highly dependent upon making good electrical connection to the electrical conductors.

In the past, practitioners of this art have attempted to use standard crimp-on connectors. It has been found that these connectors fail because of the harsh conditions, including weather (especially precipitation and wind) and mechanical movements of the conductors and connectors.

It is therefore desirable to have electrical connectors that make dependable low-resistance connections to the electrical conductors.

### SUMMARY OF THE INVENTION

According to one aspect, the invention is a connector for an apparatus for diverting a bird from attempting to roost. The apparatus causes the bird to experience an undesired or unexpected electrical sensation produced by a source of electrical energy that produces a voltage difference. The apparatus includes first lengths of first and second elongated electrical conductors respectively adapted to be subjected to the voltage difference. Each of the first lengths of the first and second elongated electrical conductors has a first end. The apparatus further includes an elongated base holding the first lengths of the first and second electrical conductors spaced apart by a substantially uniform predetermined distance so that the bird would be contacting the first and second electrical conductors simultaneously when attempting to roost, thereby completing an electrical circuit upon attempting to roost, the electrical circuit causing the electrical sensation in the bird.

The connector includes first and second connector conductors and a conductor holder. Each of the connector conductors has two ends and at least one connector portion at one of the two ends. The connector portions have predetermined cross-sections.

The conductor holder holds the connector portions of the two connector conductors apart by the predetermined distance, so that the connector portions of the first and second connector conductors respectively can be forced against the first ends of the first and second elongated electrical conductors, thereby subjecting the first and second elongated electrical conductors to the voltage difference by respectively electrically connecting the first and second elongated electrical conductors to the first and second connector conductors.

According to a second aspect, the invention is a method for making a connector for an apparatus for diverting a bird from attempting to roost. The apparatus causes the bird to experience an undesired or unexpected electrical sensation produced by a source of electrical energy that produces a voltage difference.

The apparatus includes first lengths of first and second elongated electrical conductors respectively adapted to be subjected to the voltage difference. Each of the first lengths of the first and second elongated electrical conductors has a first end. The apparatus further includes an elongated base holding the first lengths of the first and second electrical conductors spaced apart by a substantially uniform predetermined distance so that the bird would be contacting the first and second electrical conductors simultaneously when attempting to roost, thereby completing an electrical circuit upon attempting to roost, the electrical circuit causing the electrical sensation in the bird.

The method includes the steps of a) supplying first and second connector conductors, b) supplying a conductor holder, and c) placing the first and second connector conductors in the conductor holder.

In step a), each connector conductor has two ends and at least one connector portion at one of the two ends. The connector portions have predetermined cross-sections.

In step b) the conductor holder is for holding the connector portions of the two connector conductors apart by the predetermined distance. This allows the connector portions of the first and second connector conductors respectively to be forced against the first ends of the first and second elongated electrical conductors. This, in turn, thereby subjects the first and second elongated electrical conductors to the voltage difference by respectively electrically connecting the first and second elongated electrical conductors to the first and second connector conductors.

According to a still further aspect, the invention is a connector for an apparatus for diverting a bird from attempting to roost. The apparatus causes the bird to experience an undesired or unexpected electrical sensation produced by a source of electrical energy that produces a voltage difference.

The apparatus includes first lengths of first and second elongated electrical conductors respectively adapted to be subjected to the voltage difference. Each of the first lengths of the first and second elongated electrical conductors have a first end.

The apparatus further includes an elongated base holding the first lengths of the first and second electrical conductors spaced apart by a substantially uniform predetermined distance so that the bird would be contacting the first and second electrical conductors simultaneously when attempting to roost. The bird thereby completes an electrical circuit upon attempting to roost. The electrical circuit causes the electrical sensation in the bird.

The connector includes first and second connector conductor means and a conductor holder means. The first and second connector conductor means are for conducting electrical energy. Each connector conductor means is made from a conductive material and has two ends and at least one connector portion at one of the two ends. The connector portions has predetermined cross-sections.

The conductor holder means is for holding the connector portions of the two connector conductor means apart by the predetermined distance. Accordingly, the connector portions of the first and second connector conductor means respectively can be forced against the first ends of the first and second elongated electrical conductors. This subjects the first and second elongated electrical conductors to the voltage difference by respectively electrically connecting the first and second elongated electrical conductors to the first and second connector conductor means.

### BRIEF DESCRIPTION OF THE DRAWINGS

FIG. 1 is a schematic view of an apparatus for diverting a bird from attempting to roost.

FIG. 2 is a top schematic view of an apparatus for diverting a bird from attempting to roost.

FIG. 3 is a view of the top of a first embodiment of the present invention.

FIG. 4 is a perspective exploded view of the first embodiment of the present invention, showing the top and front and right sides of the first embodiment.

FIG. 5 is a cross-sectional transverse view of the right or left sides of the first embodiment of the present invention.

FIG. 6 is a close-up perspective view of a connector portion of a connector conductor in accordance with the present invention.

FIG. 7 is a view of the top of a second embodiment of the present invention.

FIG. 8 is a perspective exploded view of the second embodiment of the present invention, showing the top and front and right sides of the second embodiment.

FIG. 9 is a view of the top of a third embodiment of the present invention.

FIG. 10 is a perspective exploded view of the third embodiment of the present invention, showing the top and front and right sides of the third embodiment.

FIG. 11 is a perspective view of the first embodiment of the present invention, showing it in a first step of connection to elongated electrical conductors.

FIG. 12 is a perspective view of the first embodiment of the present invention, showing it connected to elongated electrical conductors.

### DETAILED DESCRIPTION OF THE PREFERRED EMBODIMENT OF THE INVENTION

FIG. 1 is a schematic view of an apparatus for diverting a bird from attempting to roost. The apparatus 12 includes a source of electrical energy 13 having two terminals 14 and 15. As shown, the source of electrical energy 13 generates a voltage difference V between the two terminals 14 and 15. The apparatus 12 also includes lengths of first and second elongated electrical conductors 16 and 17, which are respectively connected to the terminals 14 and 15. Consequently, the voltage difference V is also imposed between the two lengths of first and second elongated electrical conductors 16 and 17.

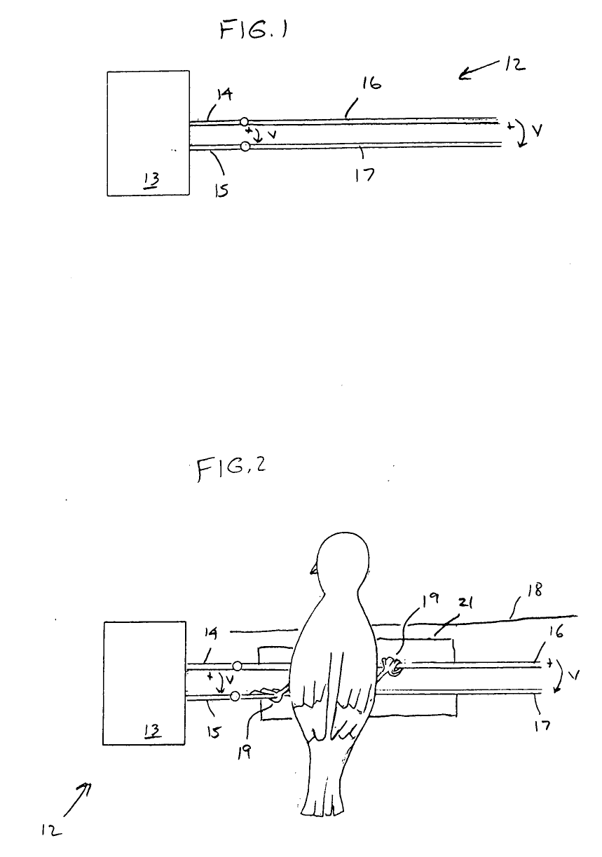

FIG. 2 is a top schematic view of an apparatus for diverting a bird from attempting to roost. FIG. 2 shows all of the features shown in FIG. 1 and also shows the first and second elongated electrical conductors 16 and 17 placed along an edge 18 of a building. FIG. 2 further shows a bird having feet 19 that is attempting to roost along the building edge 18. The bird has landed with its feet 19 across the first and second elongated electrical conductors 16 and 17. Accordingly, the bird and apparatus 12 constitute an electrical circuit. As a consequence, the voltage difference V is imposed across the body of the bird, causing the bird to experience an undesired or unexpected electrical sensation produce by the source of electrical energy 13.

The first and second elongated electrical conductors 16 and 17 are held by an elongated base 21, which holds the first and second elongated electrical conductors 16 and 17 spaced apart by a substantially uniform predetermined distance.

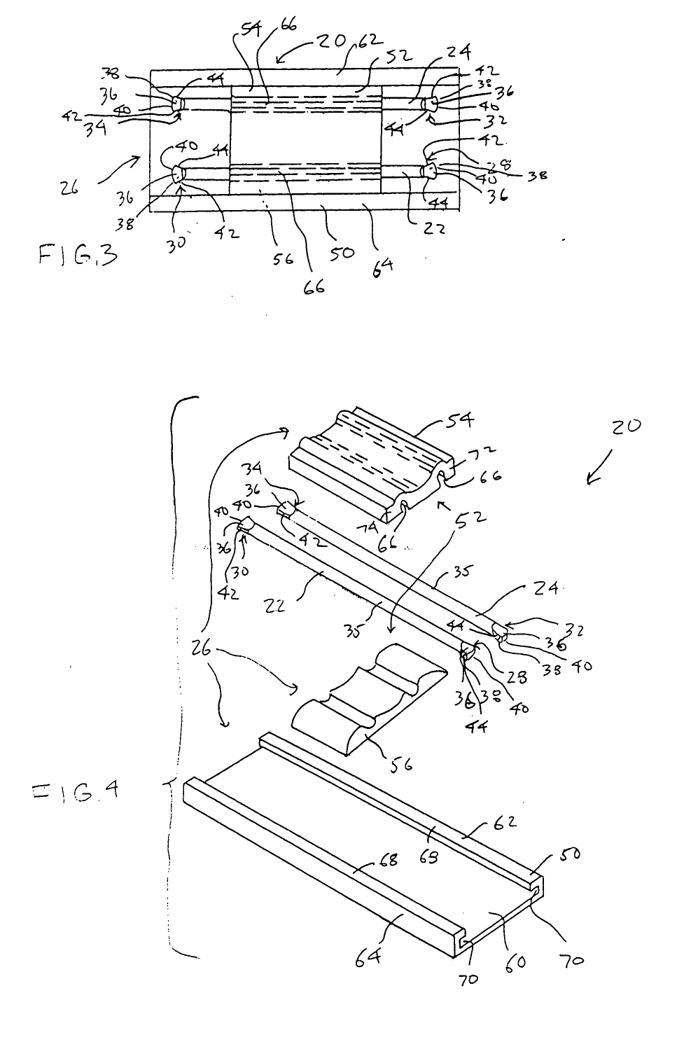

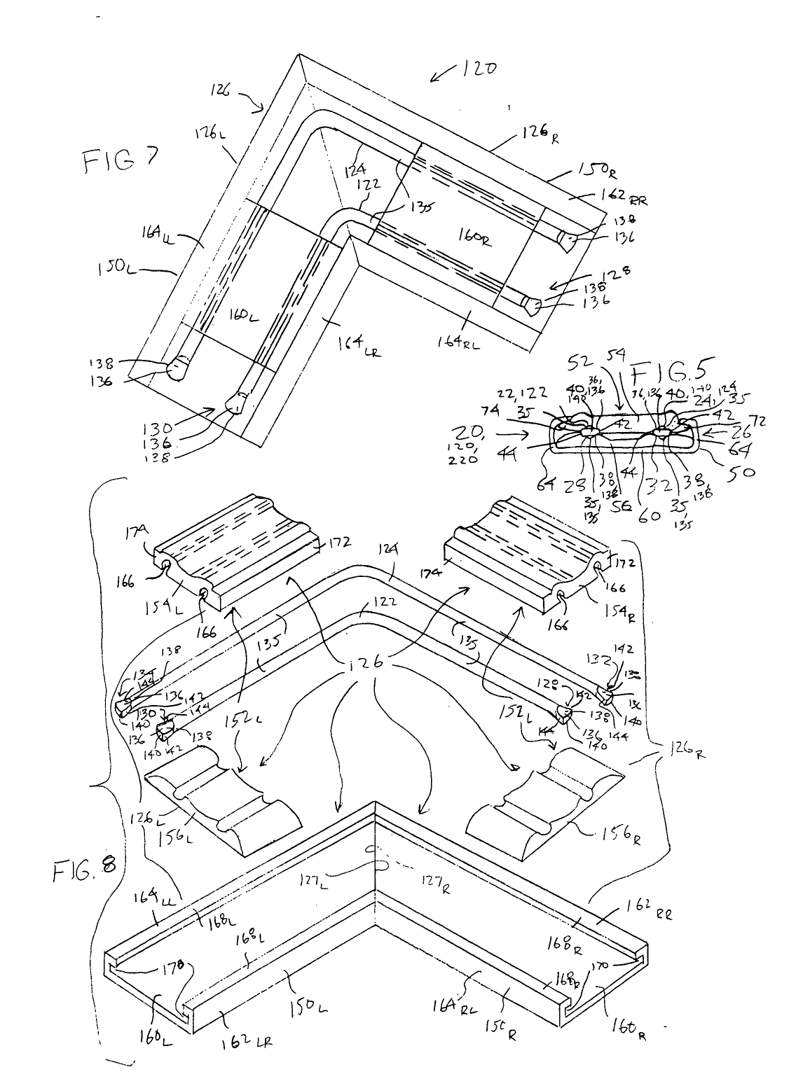

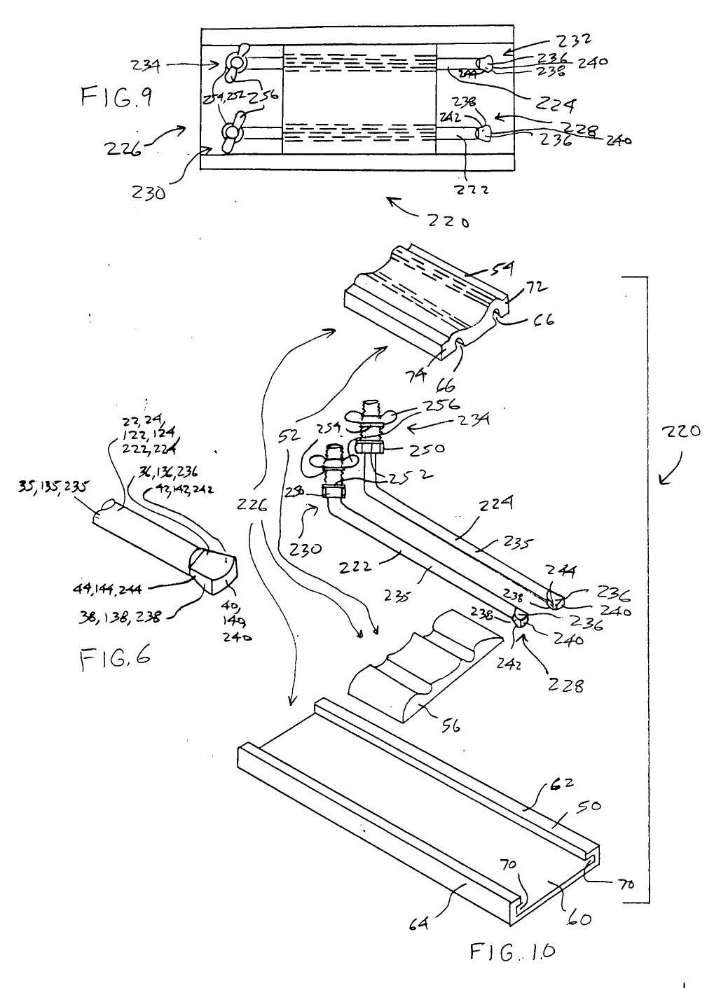

FIG. 3 is a view of the top of a first embodiment of the present invention and FIG. 4 is a perspective exploded view of the first embodiment of the present invention, showing the top and front and right sides of the first embodiment. FIG. 5 is a cross-sectional transverse view of the right or left sides of the first embodiment of the present invention. The connector 20 includes respective first and second connector conductors 22 and 24 and a conductor holder 26.

The first connector conductor 22 has respective first and second connector portions 28 and 30. The cross-sections of the first and second connector portions 28 and 30 of the first connector conductor 22 are different from the cross-section of the remainder of the first connector conductor 22.

The second connector conductor 24 has respective first and second connector portions 32 and 34. The cross-sections of the first and second connector portions 32 and 34 of the second connector conductor 24 are different from the cross-section of the remainder of the second connector conductor 24.

The first and second connector conductors 22 and 24 are parallel and substantially equal in length.

FIG. 6 is a close-up perspective view of a connector portion of a connector conductor in accordance with the present invention. As shown in FIGS. 3-6, the cross-sections of the connector portions of the connector conductors 22 and 24 are flattened and broadened relative to the circular cross-section 35 of the remainder of the connector conductors 22 and 24, giving each of,the connector portions a flattened upper surface 36 and a flattened lower surface 38, a rounded end surface 40 and rounded side surfaces 42 and 44. The flattened upper and lower surfaces 36 and 38 are parallel to each other and substantially horizontal. More particularly, each connector portion of the connector conductors 22 and 24 can be formed by flattening the ends of a length of electrically conductive wire originally having circular cross-section.

The conductor holder 26 can include an outer shell 50 and a connector conductor assembly 52. The connector conductor assembly 52 can include an upper spacer 54 and a lower spacer 56. The pieces that are included in the conductor holder 26 can be made from conventional pliable plastic materials to ease the task of assembling the conductor holder 26.

The outer shell 50 has a floor 60 and right and left sides 62 and 64, respectively. The right and left sides 62 and 64 are connected to and angled upwardly from the floor 60. The right and left sides 62 and 64 are adapted to hold the connector portions of the two connector conductors apart by the predetermined distance. The upper spacer 54 of the connector conductor assembly 52 can include grooves 66 that are adapted to hold the two connector conductors and to expose the connector portions of the two connector conductors so that the first and second electrical conductors respectively are forced against the connector portions of the two connector conductors.

The lower spacer 56 can be any piece of material that causes the first and second connector conductors 22 and 24 to have the proper spacing above the floor 60. Accordingly, it is helpful to make the lower spacer 56 from a transversely-cut portion of a plastic extrusion (shown) that is used to hold the lengths of the first and second electrical conductors spaced apart by the substantially uniform predetermined distance. The right and left sides 62 and 64 of the conductor holder 26 can have inward projections 68 that define grooves 70 in the right and left sides 62 and 64. The grooves 70 mate with projections 72 and 74 on the upper spacer 54.

The embodiment of the invention shown in FIGS. 3-6 constitutes a straight-through connector for electrically connecting together first and second lengths of first and second elongated electrical conductors.

To assemble the first embodiment, the first and second connector conductors 22 and 24 are centered relative to the longitudinal length of the upper spacer 54 and forced into the grooves 66 in the upper spacer 54. The lower spacer 56 is then placed beneath the upper spacer 54. The resulting assembly, the conductor holder 26, is then inserted longitudinally into the outer shell 50 so that the projections 72 and 74 on the upper spacer 54 engage the grooves 70 in the right and left sides 62 and 64 of the outer shell 50. The conductor holder 26 is centered longitudinally within the outer shell 50 so that the connector portions 28, 30, 32 and 34 of the first and second connector conductors 22 and 24 are exposed and elevated above the floor 60 of the outer shell 50, thereby permitting connection with first and second lengths of first and second elongated electrical conductors.

In use, the first embodiment makes a straight-through connection between the first and second elongated electrical conductors by connecting with their first ends.

FIG. 7 is a view of the top of a second embodiment of the present invention and FIG. 8 is a perspective exploded view of the second embodiment of the present invention, showing the top and front and right sides of the second embodiment. The same reference numerals are used in FIGS. 7 and 8 to describe features already described in FIGS. 3-6. FIG. 5 is also a cross-sectional transverse view of the front side of the second embodiment of the present invention. The connector 120 includes respective first and second L-shaped connector conductors 122 and 124 and left- and right-half conductor holders 126_{L} and 126_{R}. When placed together along their respective edges 127L and 127R, the left- and right-half conductor holders 126_{L} and 126_{R} form an L-shaped conductor holder 126 holding the first and second L-shaped connector conductors 122 and 124.

The first connector L-shaped conductor 122 has respective first and second connector portions 128 and 130. The cross-section of the first and second connector portions 128 and 130 of the first L-shaped connector conductor 122 are different from the cross-section of the remainder of the first L-shaped connector conductor 122.

The second L-shaped connector conductor 124 is longer than the first L-shaped connector conductor 122. The second L-shaped connector conductor 124 has respective first and second connector portions 132 and 134. The cross-sections of the first and second connector portions 132 and 134 of the second L-shaped connector conductor 124 are different from the cross-section of the remainder of the second L-shaped connector conductor 124.

FIG. 6 is a close-up perspective view of a connector portion of a connector conductor in accordance with the present invention. As shown in FIGS. 6-8, the cross-sections of the connector portions of the L-shaped connector conductors 122 and 124 are flattened and broadened relative to the circular cross-sections 135 of the remainder of the L-shaped connector conductors 122 and 124, giving each of the connector portions a flattened upper surface 136 and a flattened lower surface 138, a rounded end surface 140 and rounded side surfaces 142 and 144. The flattened upper and lower surfaces 136 and 138 are parallel to each other and substantially horizontal. More particularly, each connector portion of the L-shaped connector conductors 122 and 124 can be formed by flattening the ends of a length of electrically conductive wire originally having circular cross-section.

The left-hand conductor holder 126_{L} includes a left outer shell 150_{L} and a left connector conductor assembly 152_{L}. The right-hand conductor holder 126_{R} also includes a right outer shell 150_{R} and a right connector conductor assembly 152_{R}. The right outer shell 150_{R} and the right connector conductor assembly 152_{R} are respective mirror images of left outer shell 150_{L} and the left connector conductor assembly 152_{L}. The left connector conductor assembly 152_{L} can include a left upper spacer 154_{L} and a left lower spacer 156_{L} and the right connector conductor assembly 152_{R} can include a right upper spacer 154_{R} and a right lower spacer 156_{R}. The pieces that are included in the conductor holder 126 can be made from conventional pliable plastic materials to ease the task of assembling the conductor holder 126.

The left and right outer shells 150_{L} and 150_{R} have respective left and right floors 160_{L} and 160_{R}. The left outer shell 150_{L} also has respective right and left sides 162_{LR} and 164_{LL} and the right outer shell 150_{R} also has respective right and left sides 162_{RR} and 164_{RL}. The right and left sides 162_{LR} and 164_{LL} and the right and left sides 162_{RR} and 164_{RL} are respectively connected to and angled upwardly from the floors 160_{L} and 160_{R}. The right and left sides 162_{LR} and 164_{LL} and the right and left sides 162_{RR} and 164_{RL} are adapted to hold the connector portions of the two connector conductors apart by the predetermined distance. The upper spacers 154_{L} and 154_{R} of the respective connector conductor assemblies 152_{L} and 152_{R} can include grooves 166 that are adapted to hold the two connector conductors 124 and 126 and to expose the connector portions of the two connector conductors 124 and 126 so that the first and second electrical conductors respectively are forced against the connector portions of the two connector conductors 124 and 126.

The lower spacers 156_{L} and 156_{L} can be any piece of material that causes the first and second connector conductors 122 and 124 to have the proper spacing above the floors 160_{L} and 160_{R}. Accordingly, it is helpful to make the lower spacers 156_{L} and 156_{R} from transversely-cut portions of a plastic extrusion (shown) that is used to hold the lengths of the first and second electrical conductors spaced apart by the substantially uniform predetermined distance. The right and left sides 162_{LR} and 164_{LL} of the conductor holder 126_{L} can have inward projections 168_{L} that define grooves 170 in the right and left sides 162_{LR} and 164_{LL}. The right and left sides 162_{RR} and 164_{RL} of the conductor holder 126_{R} can have inward projections 168_{R} that define grooves 170 in the right and left sides 162_{RR} and 164_{RL}. The grooves 170 mate with projections 172 and 174 on the upper spacers 154_{L} and 154_{R}.

The embodiment of the invention shown in FIGS. 6-8 constitutes an angled connector for electrically connecting together first and second lengths of first and second elongated electrical conductors. More particularly, the embodiment of the invention shown in FIGS. 6-8 constitutes a right-angled connector.

To assemble the second embodiment, each of the two legs of the L-shaped first and second connector conductors 122 and 124 are centered relative to the longitudinal lengths of the upper spacers 154_{L} and 154_{R} and forced into the grooves 166 in the upper spacers 154_{L} and 154_{R}. The lower spacers 156_{L} and 156_{R} are then placed beneath the upper spacers 154_{L} and 154_{R}. The resulting assembly, the conductor holder 126, is then inserted longitudinally into the left and right outer shells 150_{L} and 150_{R} so that the projections 72 and 74 on the upper spacers 154_{L} and 154_{R} engage the grooves 170 in the right sides 162LR and 162RR and the left sides 164_{LL} and 164_{RL} of the left and right outer shells 150_{L} and 150_{R}. The conductor holders 126_{L} and 126_{R} are centered longitudinally within the outer shells 150_{L} and 150_{R} so that the connector portions 128, 130, 132 and 134 of the first and second connector conductors 122 and 124 are respectively exposed and elevated above the floors 160_{L} and 160_{R} of the outer shells 150_{L} and 150_{R}, thereby permitting connection with first and second lengths of first and second elongated electrical conductors.

In use, the second embodiment connects first and second elongated electrical conductors together, when they are at a relative angle of less than 180 degrees, by connecting with their first ends.

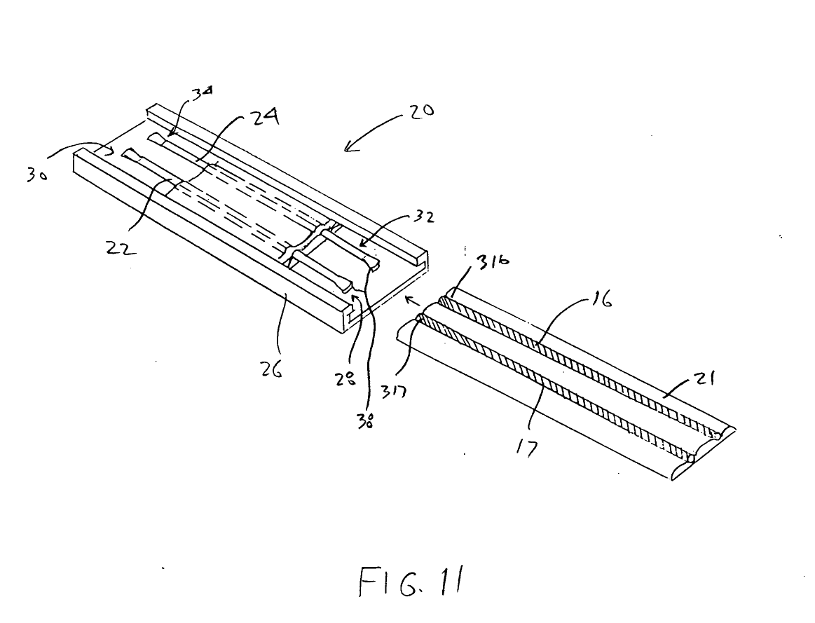

FIG. 9 is a view of the top of a third embodiment of the present invention, and FIG. 10 is a perspective exploded view of the third embodiment of the present invention, showing the top and front and right sides of the third embodiment.

The same reference numerals are used in FIGS. 9 and 10 to describe features already described in FIGS. 3-8. FIG. 5 is also a cross-sectional transverse view of the front side of the third embodiment of the present invention. The connector 220 includes respective first and second connector conductors 222 and 224 and a conductor holder 226.

The first connector conductor 222 has respective first and second connector portions 228 and 230. The cross-sections of the first and second connector portions 228 and 230 of the first connector conductor 222 are different from the cross-section of the remainder of the first connector conductor 222.

The second connector conductor 224 has respective first and second connector portions 232 and 234. The cross-sections of the first and second connector portions 232 and 234 of the second connector conductor 224 are different from the cross-section of the remainder of the second connector conductor 224.

The first and second connector conductors 222 and 224 are parallel and substantially equal in length.

As shown in FIGS. 6, 9 and 10, the cross-sections of the connector portions of the connector conductors 222 and 224 are flattened and broadened relative to the circular cross-section 235 of the remainder of the connector conductors 222 and 224, giving both of the connector portions 232 and 234 a flattened upper surface 236 and a flattened lower surface 238, a rounded end surface 240 and rounded side surfaces 242 and 244. The flattened upper and lower surfaces 236 and 238 are parallel to each other and substantially horizontal. More particularly, each connector portion of the connector conductors 222 and 224 can be formed by flattening the ends of a length of electrically conductive wire originally having circular cross-section.

The conductor holder 226 can include an outer shell 50 and a connector conductor assembly 52. The connector conductor assembly 52 can include an upper spacer 54 and a lower spacer 56. The pieces that are included in the conductor holder 226 can be made from conventional pliable plastic materials to ease the task of assembling the conductor holder 226.

The outer shell 50 has a floor 60 and right and left sides 62 and 64, respectively. The right and left sides 62 and 64 are connected to and angled upwardly from the floor 60. The right and left sides 62 and 64 are adapted to hold the connector portions of the two connector conductors apart by the predetermined distance. The upper spacer 54 of the connector conductor assembly 52 can include grooves 66 that are adapted to hold the two connector conductors and to expose the connector portions of the two connector conductors so that the first and second electrical conductors respectively are forced against the connector portions of the two connector conductors.

The lower spacer 56 can be any piece of material that causes the first and second connector conductors 222 and 224 to have the proper spacing above the floor 60. Accordingly, it is helpful to make the lower spacer 56 from a transversely-cut portion of a plastic extrusion (shown) that is used to hold the lengths of the first and second electrical conductors spaced apart by the substantially uniform predetermined distance. The right and left sides 62 and 64 of the conductor holder 226 can have inward projections 68 that define grooves 70 in the right and left sides 62 and 64. The grooves 70 mate with projections 72 and 74 on the upper spacer 54.

The second connector portions 230 and 234 are respectively bent upwardly relative to the remainder of the connector conductors 222 and 224. The connector portions 230 and 234 include hardware that allows the two terminals of the source of electrical energy, respectively, to be connected to the connector conductors 22 and 224. As shown in FIGS. 9 and 10, the connector portions 230 and 234 are both threaded and can each include a stop nut 250, a lower stop washer 252, an upper stop washer 254, and a wing nut 256. Conventional wires connected to the two terminals of the source of electrical energy can be wound around the connector portions 230 and 234 and squeezed between the upper and lower stop washers 252 and 254 by tightening the wing nut 256 toward the stop nut 250. The third embodiment can also take the form of other variations known to those skilled in the relevant arts.

The embodiment of the invention shown in FIGS. 6, 9 and 10 constitute a straight-through connector for electrically connecting the two electrical terminals on the source of electrical energy to the first lengths of first and second elongated electrical conductors, thereby imposing the voltage difference produced between the two electrical terminals on the source of electrical energy onto the first lengths of the first and second elongated electrical conductors.

To assemble the third embodiment, the first and second connector conductors 222 and 224 are centered relative to the longitudinal length of the upper spacer 54 and forced into the grooves 66 in the upper spacer 54. The lower spacer 56 is then placed beneath the upper spacer 54. The resulting assembly, the conductor holder 226, is then inserted longitudinally into the outer shell 50 so that the projections 72 and 74 on the upper spacer 54 engage the grooves 70 in the right and left sides 62 and 64 of the outer shell 50. The conductor holder 226 is centered longitudinally within the outer shell 50 so that the connector portions 228, 230, 232 and 234 of the first and second connector conductors 222 and 224 are exposed and elevated above the floor 60 of the outer shell 50 and so that the connector portions 230 and 234 are pointing upwardly, thereby permitting respective connection with first lengths of first and second elongated electrical conductors and with the two electrical terminals of a source of electrical energy.

In use, the third embodiment connects elongated electrical conductors to the two terminals of a source of electrical energy by connecting the first ends of the elongated electrical conductors to the two terminals.

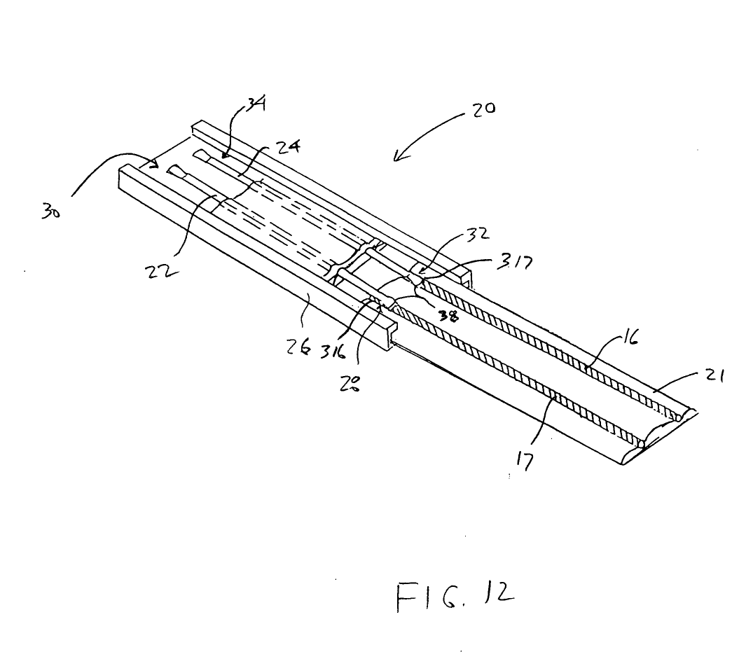

FIG. 11 is a perspective view of the first embodiment of the present invention, showing it in a first step of connection to elongated electrical conductors. In the first step, the elongated base 21 is pushed toward the conductor holder 26 so that the electrical conductors 16 and 17 are respectively aligned with the connector conductors 24 and 22 and so that the leading ends 316 and 317 are respectively pushed toward the first and second connector portions 32 and 28.

FIG. 12 is a perspective view of the first embodiment of the present invention, showing it connected to elongated electrical conductors. After connection, the leading ends 316 and 317 are respectively forced under, and in intimate electrical contact with, the flattened lower surfaces 38 of the connector conductors 22 and 24.

While the foregoing is a detailed description of the preferred embodiment of the invention, there are many alternative embodiments of the invention that would occur to those skilled in the art and which are within the scope of the present invention. Accordingly, the present invention is to be determined by the following claims.

1. A connector for an apparatus for diverting a bird from attempting to roost, the apparatus causing the bird to experience an undesired or unexpected electrical sensation produced by a source of electrical energy that produces a voltage difference, the apparatus including first lengths of first and second elongated electrical conductors respectively adapted to be subjected to the voltage difference, each of the first lengths of the first and second elongated electrical conductors having a first end, the apparatus further including an elongated base holding the first lengths of the first and second electrical conductors spaced apart by a substantially uniform predetermined distance so that the bird would be contacting the first and second electrical conductors simultaneously when attempting to roost, thereby completing an electrical circuit upon attempting to roost, the electrical circuit causing the electrical sensation in the bird, the connector comprising:
first and second connector conductors, each connector conductor having two ends and at least one connector portion at one of the two ends, the connector portions having predetermined cross-sections; and
a conductor holder for holding the connector portions of the two connector conductors apart by the predetermined distance, so that the connector portions of the first and second connector conductors respectively can be forced against the first ends of the first and second elongated electrical conductors, thereby subjecting the first and second elongated electrical conductors to the voltage difference by respectively electrically connecting the first and second elongated electrical conductors to the first and second connector conductors.

2. The connector of claim 1, wherein the conductor holder includes an outer shell having a floor and two retaining sides adjacent the floor, the two retaining sides being adapted to support the first ends of the first and second elongated electrical conductors above the floor so that the connector portions of the first and second connector conductors respectively are forced against the first and second elongated electrical conductors, thereby respectively electrically connecting the first and second elongated electrical conductors to the first and second connector conductors.

3. The connector of claim 2, wherein the two retaining sides have grooves that mate with the conductor holder.

4. The connector of claim 1, wherein the conductor holder includes grooves adapted to hold the two connector conductors and to expose the connector portions of the two connector conductors so that the first and second electrical conductors respectively are forced against the connector portions of the two connector conductors.

5. The connector of claim 1, wherein the connector is adapted to electrically connect first lengths of the first and second elongated electrical conductors to second lengths of the first and second elongated electrical conductors.

6. The connector of claim 5, wherein the connector is a straight-through connector.

7. The connector of claim 5, wherein the connector is an angled connector.

8. The connector of claim 1, wherein the voltage difference is produced between two electrical terminals on the source of electrical energy and the connector is adapted to electrically connect the two electrical terminals to the first lengths of the first and second elongated electrical conductors.

9. The connector of claim 1, wherein the connector portions of the first and second connector conductors have different cross-sections from the cross-sections of the remainder of first and second connector conductors.

10. The connector of claim 2, wherein the connector portions of the first and second connector conductors have cross-sections with a lower surface that is parallel to the floor of the outer shell and the cross-sections of the remainder of the first and second connector conductors are circular.

11. A method for making a connector for an apparatus for diverting a bird from attempting to roost, the apparatus causing the bird to experience an undesired or unexpected electrical sensation produced by a source of electrical energy that produces a voltage difference, the apparatus including first lengths of first and second elongated electrical conductors respectively adapted to be subjected to the voltage difference, each of the first lengths of the first and second elongated electrical conductors having a first end, the apparatus further including an elongated base holding the first lengths of the first and second electrical conductors spaced apart by a substantially uniform predetermined distance so that the bird would be contacting the first and second electrical conductors simultaneously when attempting to roost, thereby completing an electrical circuit upon attempting to roost, the electrical circuit causing the electrical sensation in the bird,
the method comprising the steps of:
a) supplying first and second connector conductors, each connector conductor having two ends and at least one connector portion at one of the two ends, the connector portions having predetermined cross-sections;
b) supplying a conductor holder for holding the connector portions of the two connector conductors apart by the predetermined distance, so that the connector portions of the first and second connector conductors respectively can be forced against the first ends of the first and second elongated electrical conductors, thereby subjecting the first and second elongated electrical conductors to the voltage difference by respectively electrically connecting the first and second elongated electrical conductors to the first and second connector conductors; and
c) placing the first and second connector conductors in the conductor holder.

12. The method of claim 11, wherein step b) includes the step of:
b1) forming an outer shell in the conductor holder, the outer shell having a floor and two retaining sides adjacent the floor, the two retaining sides being adapted to support the first ends of the first and second elongated electrical conductors above the floor so that the connector portions of the first and second connector conductors respectively are forced against the first and second elongated electrical conductors, thereby respectively electrically connecting the first and second elongated electrical conductors to the first and second connector conductors.

13. The method of claim 12, wherein the two retaining sides have grooves that mate with the conductor holder.

14. The method of claim 11, wherein step b) includes the step of:
b1) including grooves in the conductor holder, the grooves being adapted to hold the two connector conductors and to expose the connector portions of the two connector conductors so that the first and second electrical conductors respectively are forced against the connector portions of the two connector conductors.

15. The method of claim 11, wherein step b) includes the step of:
b1) adapting the connector to electrically connect first lengths of the first and second elongated electrical conductors to second lengths of the first and second elongated electrical conductors.

16. The method of claim 11, wherein the voltage difference is produced between two electrical terminals on the source of electrical energy and the method includes the step of:
d) adapting the connector to electrically connect the two electrical terminals to the first lengths of the first and second elongated electrical conductors.

17. The method of claim 11, wherein step a) includes the step of:
a1) forming the connector portions of the first and second connector conductors to have different cross-sections from the cross-sections of the remainder of first and second connector conductors.

18. The method of claim 12, wherein step a) includes the step of:
a1) forming the connector portions of the first and second connector conductors to have cross-sections with a lower surface that is parallel to the floor of the outer shell, the cross-sections of the remainder of the first and second connector conductors being circular.

19. A connector for an apparatus for diverting a bird from attempting to roost, the apparatus causing the bird to experience an undesired or unexpected electrical sensation produced by a source of electrical energy that produces a voltage difference, the apparatus including first lengths of first and second elongated electrical conductors respectively adapted to be subjected to the voltage difference, each of the first lengths of the first and second elongated electrical conductors having a first end, the apparatus further including an elongated base holding the first lengths of the first and second electrical conductors spaced apart by a substantially uniform predetermined distance so that the bird would be contacting the first and second electrical conductors simultaneously when attempting to roost, thereby completing an electrical circuit upon attempting to roost, the electrical circuit causing the electrical sensation in the bird,
the connector comprising:
first and second connector conductor means for conducting electrical energy, each connector conductor means being made from a conductive material and having two ends and at least one connector portion at one of the two ends, the connector portions having predetermined cross-sections; and
a conductor holder means for holding the connector portions of the two connector conductor means apart by the predetermined distance, so that the connector portions of the first and second connector conductor means respectively can be forced against the first ends of the first and second elongated electrical conductors, thereby subjecting the first and second elongated electrical conductors to the voltage difference by respectively electrically connecting the first and second elongated electrical conductors to the first and second connector conductor means.

20. The connector of claim 19, wherein the conductor holder means includes an outer shell having a floor and two retaining sides adjacent the floor, the two retaining sides being adapted to support the first ends of the first and second elongated electrical conductors above the floor so that the connector portions of the first and second connector conductor means respectively are forced against the first and second elongated electrical conductors, thereby respectively electrically connecting the first and second elongated electrical conductors to the first and second connector conductor means.

22. The connector of claim 20, wherein the two retaining sides have grooves that mate with the conductor holder.

23. The connector of claim 19, wherein the conductor holder means includes grooves adapted to hold the two connector conductor means and to expose the connector portions of the two connector conductor means so that the first and second electrical conductors respectively are forced against the connector portions of the two connector conductor means.

24. The connector of claim 19, wherein the connector is adapted to electrically connect first lengths of the first and second elongated electrical conductor means to second lengths of the first and second elongated electrical conductors.

25. The connector of claim 24, wherein the connector is a straight-through connector.

26. The connector of claim 24, wherein the connector is an angled connector.

27. The connector of claim 20, wherein the voltage difference is produced between two electrical terminals on the source of electrical energy and the connector is adapted to electrically connect the two electrical terminals to the first lengths of the first and second elongated electrical conductors.

28. The connector of claim 19, wherein the connector portions of the first and second connector conductor means have different cross-sections from the cross-sections of the remainder of first and second connector conductor means.

29. The connector of claim 20, wherein the connector portions of the first and second connector conductor means have cross-sections with a lower surface that is parallel to the floor of the outer shell, and the cross-sections of the remainder of the first and second connector conductor means are circular.
